(19) United States
(12) Patent Application Publication
(10) Pub. No.: US 2020/0257965 A1
(43) Pub. Date: Aug. 13, 2020

(54) CAPSULE VECTOR SPIN NEURON IMPLEMENTATION OF A CAPSULE NEURAL NETWORK PRIMITIVE

(71) Applicant: INTEL CORPORATION, Santa Clara, CA (US)

(72) Inventors: Sasikanth Manipatruni, Portland, OR (US); Dmitri Nikonov, Beaverton, OR (US); Ian Young, Portland, OR (US)

(73) Assignee: INTEL CORPORATION, Santa Clara, CA (US)

(21) Appl. No.: 16/271,273

(22) Filed: Feb. 8, 2019

(51) Int. Cl. G06N 3/063; G06N 3/04; G06F 17/16

(52) U.S. Cl. CPC G06N 3/063; G06F 17/16; G06N 3/0481

(57) ABSTRACT

Techniques are provided for implementing capsule neural networks (NNs) using vector spin neurons. A vector spin neuron according to an embodiment includes a first magnet, polarized in a first direction, to receive a first input current. The first input current is based on an NN input value and weighting factor. The vector spin neuron also includes a second magnet, polarized in a direction orthogonal to the first direction, to receive a second input current. The second input current is based on a second NN input value and weighting factor. The first and second magnets generate spin polarized currents. In some such embodiments, the vector spin neuron further includes a third magnet, which is unpolarized, and a conductor to couple output regions of the first and second magnets to an input region of the third magnet. The third magnet applies a non-linear activation function to the sum of the spin polarized currents.

### BACKGROUND

Artificial intelligence (AI) systems and applications using neural networks are becoming increasingly important in many areas. There remain, however, a number of non-trivial issues with respect to the operation of neural networks.

### BRIEF DESCRIPTION OF THE DRAWINGS

FIG. 1 is a block diagram of a capsule vector neuron, configured in accordance with certain embodiments of the present disclosure.

FIG. 2 illustrates a vector spin neuron, configured in accordance with certain embodiments of the present disclosure.

FIG. 3 illustrates another vector spin neuron, configured in accordance with certain other embodiments of the present disclosure.

FIG. 4 illustrates a cross-section of a portion of a vector spin neuron, configured in accordance with certain embodiments of the present disclosure.

FIG. 5 is a block diagram of a capsule neural network, configured in accordance with certain embodiments of the present disclosure.

FIG. 6 is a flowchart illustrating a methodology for vector spin neuron processing, in accordance with certain embodiments of the present disclosure.

FIG. 7 is a block diagram schematically illustrating a device platform configured to employ capsule neural network, in accordance with certain embodiments of the present disclosure.

Although the following Detailed Description will proceed with reference being made to illustrative embodiments, many alternatives, modifications, and variations thereof will be apparent in light of this disclosure.

### DETAILED DESCRIPTION

As previously noted, there remain a number of non-trivial issues with respect to the operation of neural networks (NNs). Particularly the issues relate to limitations of neural networks in working with and preserving the vector nature of features that are associated with the task to which they are applied. For instance, in image processing applications, convolutional neural networks generally have difficulty capturing relative vector locations of the features of the image. Capsule neural networks, which employ vector neurons as opposed to scalar neurons, offer a solution to this vector-based problem and can enable the NN to capture features of the physical world in greater detail. Thus, this disclosure provides techniques for efficient implementation of capsule NNs, which in some embodiments is accomplished using vector spin neurons as a hardware accelerator to improve the performance of the vector operations that are associated with a capsule neuron. These operations, which may include vector multiplication, scalar multiplication, vector summing, and/or vector thresholding, are performed, for example, using spin current generation, scaling, and spin torque switching, as will be explained in greater detail below. The resulting capsule NN may be configured to form a convolutional NN, a recursive NN, or any desired type of deep NN.

The disclosed techniques can be implemented, for example, as a capsule NN on an integrated circuit (IC) or chip set, although other embodiments will be apparent. The capsule NN may comprise any number of inter-connected vector spin neurons. Thus, in accordance with an embodiment, a vector spin neuron includes a first magnet, polarized in a first direction, to receive a first input current. The first input current is based on a first NN input value and weighting factor. The vector spin neuron also includes a second magnet, polarized in a direction orthogonal to the first direction, to receive a second input current. The second input current is based on a second NN input value and weighting factor. The first and second magnets generate spin polarized currents based on the associated input currents. In some such embodiments, the vector spin neuron further includes a third magnet, which is unpolarized, and a conductor to couple output regions of the first and second magnets to an input region of the third magnet. The third magnet applies a non-linear activation function, using spin torque switching, to the sum of the spin polarized currents to generate an output for the vector spin neuron.

As will be appreciated, the techniques described herein, employing vector spin neurons, may allow for improved neural network performance, compared to networks that use scalar neurons, on tasks that involve vector oriented features, such as the rotation and expansion transforms of shapes and relative positions of shapes within objects. The advantages of vector spin neurons pertain to image and video recognition (or any other applications that involve vector-based features). The disclosed techniques can be implemented on a broad range of intelligent platforms that may employ capsule neural networks, including laptops, tablets, smart phones, workstations, video conferencing systems, gaming systems, smart home control systems, and robotic systems. Numerous embodiments will be appreciated in light of this disclosure.

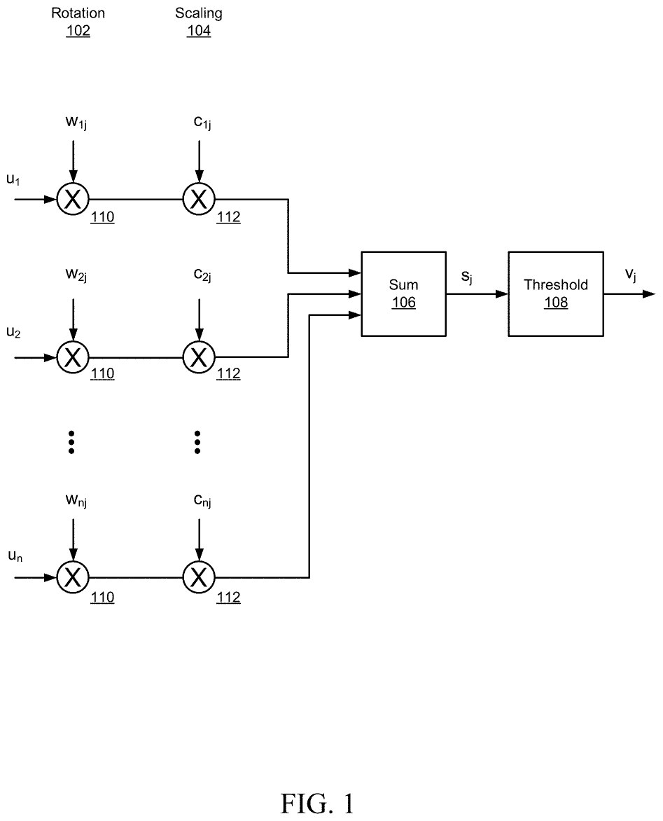

FIG. 1 is a block diagram of a capsule vector neuron 100, configured in accordance with certain embodiments of the present disclosure. The capsule vector neuron 100 shown to include multiplication circuits 110, configured to perform rotation operations 102 (or other affine transformations) on the input vector u, based on rotation matrices W. The capsule vector neuron 100 is also shown to include multiplication circuit 112, configured to perform scaling operations 104 based on scale factors c corresponding to contractions and expansions as well as reflections relative to certain directions. The capsule vector neuron 100 is also shown to include summation circuit 106, and thresholding circuit 108, configured to generate an output vector v. In some embodiments, the operation of the capsule vector neuron 100 may be described by the following equations:

$${s}_{j} = {\sum }_{i = 0}^{n} {c}_{ij} {W}_{ij} {u}_{i}$$

$${v}_{j} = g ( {s}_{j} )$$

where uᵢ are elements of the input vector u, Wᵢⱼ are elements of the rotation matrix W, cᵢⱼ are scale factors, sⱼ are elements of the vector s resulting from the summation, g(⋅) is the non-linear activation function used for thresholding, and vⱼ are elements of the output vector v. The first equation can be simplified by incorporating the scale factor into the rotation matrix as \tilde{W}ⱼ=cᵢⱼWᵢⱼ, resulting in:

$${s}_{j} = {\sum }_{i = 0}^{n} {\tilde{W}}_{ij} {u}_{i}$$

The following table provides a summary of the differences between the vector operations performed by a capsule neuron versus the operations performed by a scalar neuron.

Capsule vs. Traditional Neuron

| Input from low-level | | | |
|---|---|---|---|
| capsule/neuron | | vector(uᵢ) | scalar(xᵢ) |
| Operation | Affine | û_{j\|i} = Wᵢⱼuᵢ | — |
| | Transform | | |
| | Weighting | sⱼ = Σᵢ cᵢⱼû_{j\|i} | aⱼ = Σᵢ wᵢxᵢ + b |
| | Sum | | |
| | Nonlinear Activation | ${v}_{j} = \frac{{‖ {s}_{j} ‖}^{2}}{1 + {‖ {s}_{j} ‖}^{2}} \frac{{s}_{j}}{‖ {s}_{j} ‖}$ | hⱼ = f(aⱼ) |

| | | |
|---|---|---|
| Output | vector(vⱼ) | scalar(hⱼ) |

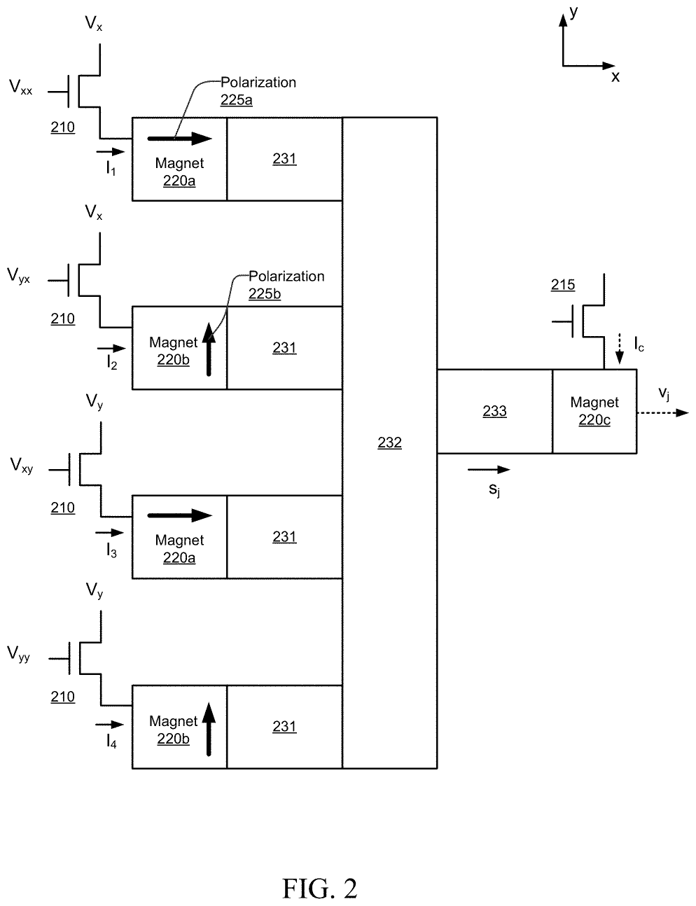

FIG. 2 illustrates a vector spin neuron 200, configured in accordance with certain embodiments of the present disclosure. The vector spin neuron 200 is configured to implement the functionality of the capsule vector neuron 100 for a two-dimensional case, as will be explained below. It will be appreciated that higher dimensions can be handled by cascading two-dimensional vector spin neurons.

For the two-dimensional case, the capsule neuron equations can be rewritten as follows:

sₓ=\tilde{W}xₓuₓ+\tilde{W}_{xy}u_{y}

s_{y}=\tilde{W}_{yx}uₓ+\tilde{W}_{yy}u_{y}

vₓ=g(sₓ)

v_{y}=g(s_{y})

The vector spin neuron 200 is shown to include driving transistors 210, magnets 220a, 220b, 220c, and conductors 231, 232, 233. The view presented in FIG. 2 is a top-down view in the x,y plane. The inputs uₓ and u_{y} are encoded as source voltages Vₓ and V_{y} applied to the driving transistors 210. The weights Wₓₓ, W_{yx}, W_{xy}, and W_{yy} are encoded as conductance values of the driving transistors 210, which are determined by the voltages Vₓₓ, V_{yx}, V_{xy}, and V_{yy} applied to the transistor gates. In response to the source voltages and gate voltages (i.e., capsule neuron inputs and weights), the transistors generate currents I₁, I₂, I₃, and I₄ which are provided as input currents to the magnets 220a and 220b.

Magnets 220a and 220b are configured to be anisotropic, which is to say that they favor a fixed magnetization direction or polarization. For example, a rectangular magnet favors magnetization along the long axis of the magnet. Magnets 220a are configured with a polarization direction 225a in the x direction, as indicated, while magnets 220b are configured with a polarization direction 225b in the y direction, which is orthogonal to direction 225a, also as indicated. Magnets 220a and 220b transform the input currents I₁, I₂, I₃, and I₄ into spin polarized currents I₁ₛₚᵢₙ, I₂ₛₚᵢₙ, I₃ₛₚᵢₙ, and I₄ₛₚᵢₙ based on the polarization of each magnet.

Conductors 231, 232, 233 provide a conductive path or channel for the spin polarized currents to flow from the magnets 220a and 220b, to be summed at conductor 232 and provided as an input Iₛ to magnet 220c. The summed spin polarized currents can be expressed as a vector with x and y components:

Sₓ=I_{s,x}

S_{y}=I_{s,y}

The summation of the spin polarized currents results in a vector rotation that is based on the relative contributions (current magnitudes) of each of the spin polarized currents being summed. For example, if I_{s,x} and I_{s,y} are equal, the resulting vector rotation would be 45 degrees.

Magnet 220c is configured to be isotropic or only slightly anisotropic, such that no particular polarization is favored. In some embodiments, magnet 220c may be a paramagnetic material rather than a ferromagnetic material. This allows the magnetization direction of magnet 220c to be determined by the applied spin torque resulting from vector components Sₓ, S_{y}. The magnetization under the action of spin torque produced by the spin polarized current Iₛ may be expressed by the following equation:

$$M = {M}_{s} tanh ( \frac{ℏ {gI}_{s}}{{eN}_{s} {k}_{B} T} )$$

where Mₛ is the saturation magnetization property of magnet 220c, ℏ is Planck's constant, g is the Lande factor, e is the electron charge, Nₛ is the number of spins (elementary magnetic moments) in the magnet, k_{B} is Boltzmann's constant, and T is temperature. The hyperbolic tangent function (tanh) implements the non-linear activation function g(⋅) to generate the thresholded vector output vⱼ. If a charge current I_{c} is conducted through the magnet (as provide, for example, by transistor 215), it will acquire spin polarization proportional to the magnetization, therefore the spin polarized component of the current exiting the magnet will be Iₛ˜IM.

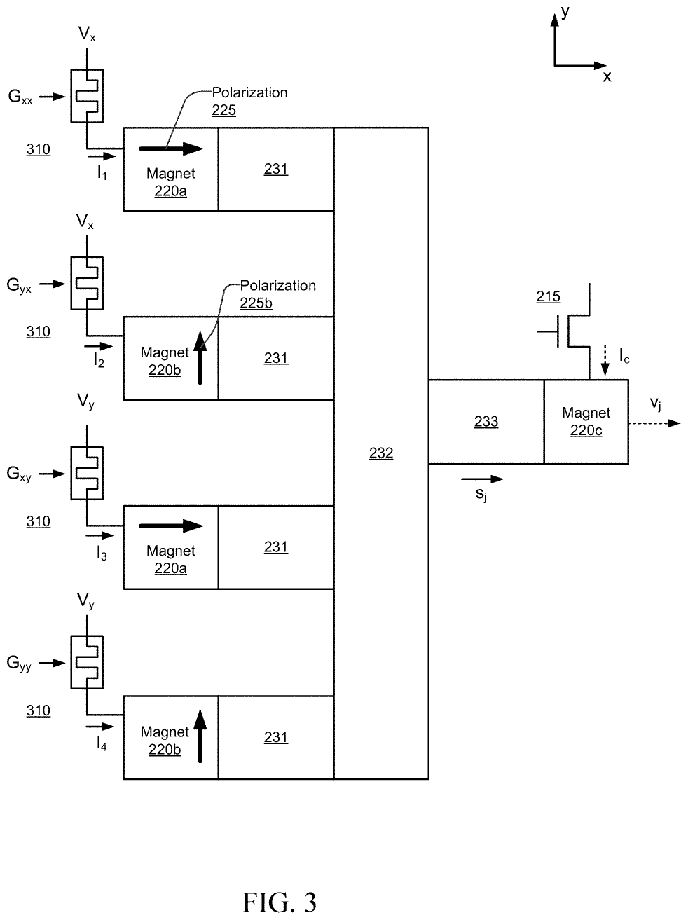

FIG. 3 illustrates another vector spin neuron 300, configured in accordance with certain other embodiments of the present disclosure. The vector spin neuron 300 in this embodiment is similar to the vector spin neuron 200 described previously, with the exception that the driving transistors 210 are replaced with memristor devices 310. The inputs uₓ and u_{y} are encoded as source voltages Vₓ and V_{y} applied to the memristors 310. The weights Wₓₓ, W_{yx}, W_{xy}, and W_{yy}, however, are encoded as conductance values Gₓₓ, G_{yx}, G_{xy}, and G_{yy} of the memristors, which are determined by applying a specified number of current pulses (above a device specific threshold value) to memristors, in some embodiments.

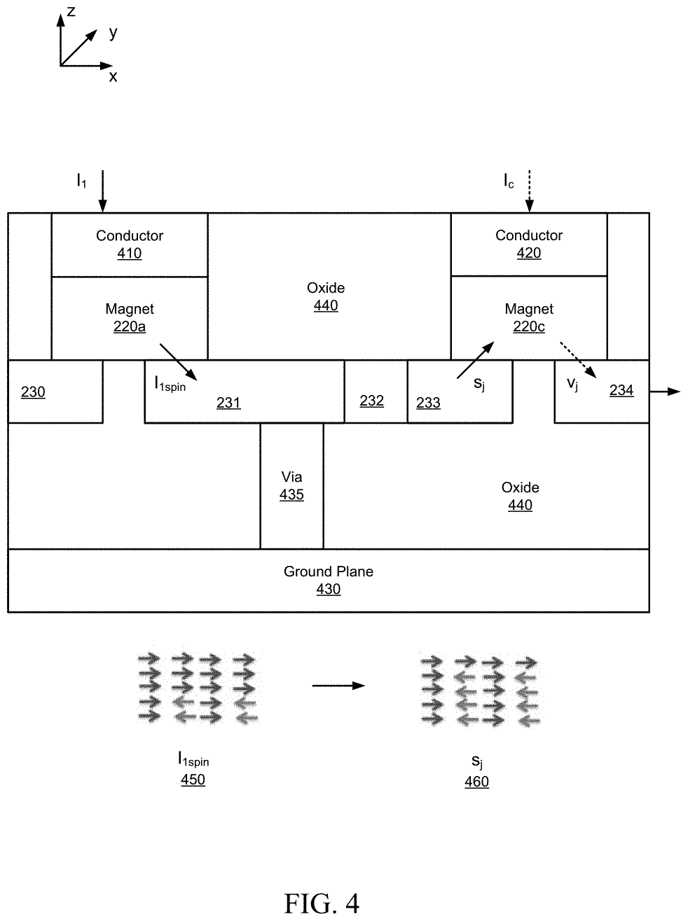

FIG. 4 illustrates a cross-section 400 of a portion of a vector spin neuron, configured in accordance with certain embodiments of the present disclosure. The view presented in FIG. 4 is a side-view (or cross-section), in the x,z plane, of one row of the vector spin neuron 200. The input charge current I₁ (generated by transistor 210 or memristor 310, not shown) is supplied through conductor 410 to an input region (left side) of magnet 220a. Spin polarized current I₁ₛₚᵢₙ is generated at the output region (right side) of magnet 220a and flows through conductor 231, and is summed with the other spin polarized currents I₂ₛₚᵢₙ, I₃ₛₚᵢₙ, and I₄ₛₚᵢₙ (not shown), at summing junction conductor 232, to generate s₁ to be provided to an input region (left side) of magnet 220c, through conductor 233. In the next stage of the calculation (at a subsequent point in time), the input spin current s₁ stops, and a charge current I_{c} (generated by transistor 215, not shown) is supplied through conductor 420 to an input region (right side) of magnet 220c. The thresholded output vⱼ is provided as a spin polarized current at the output region (right side) of magnet 220c and flows through conductor 234, for example as input to conductor 230 of another vector spin neuron. I_{c} and vⱼ are shown as dotted line arrows to indicate that they occur at a subsequent moment in time relative to the input charge current I₁.

In some embodiments, the drift (i.e., voltage driven) part of the charge current may flow through a vertical via 435 to a ground plane 430. Meanwhile, the spin polarized current may comprise the diffusion component of the charge current (i.e., driven by the difference of spin concentration). These various components may be separated/insulated from one another by an oxide material, 440. The spin polarization (and equivalently the magnitude of the spin polarized current) decreases as the spin polarized current flows through a conductor, typically with an exponential dependence on the length of the conductor. In some embodiments, the scale factors cᵢⱼ may compensate for varying decrease of spin polarization due to differences in the length of the channels between magnets 220a, 220b and magnet 220c.

The spin polarizations of I₁ₛₚᵢₙ and sⱼ are illustrated as a collection of arrows 450 and 460 respectively. Each arrow represents an electron. The direction of the arrows is employed as a notational mechanism to indicate the spin polarization of the electron. In this example, I₁ₛₚᵢₙ is shown to have a greater number of right pointing arrows than left pointing arrows indicating an overall spin polarization, imparted by magnet 220a, in the right pointing direction. Further to this example, s₁ is shown to also have a greater number of right pointing arrows than left pointing arrows, although not in the same proportion as I₁ₛₚᵢₙ. This reduction in net spin can be due both to the fact that the spin polarization effect weakens over distance, and to the fact that s₁ is a sum of the other spin polarized current I₂ₛₚᵢₙ, I₃ₛₚᵢₙ, and I₄ₛₚᵢₙ which may have different net polarizations to contribute.

In some embodiments, the input currents I₁, I₂, I₃, and I₄ may be in the range of 10-200 uA and the spacing between magnets 220a and 220c (e.g., the combined length of the conductors 231, 232, 233) may be on the order of 100 nm.

In some embodiments, magnets 220a, 220b, 220c may be formed of a ferromagnetic material such as, for example, cobalt (Co), iron (Fe), nickel (Ni), gadolinium (Gd), their alloys, or a Heusler alloy of the form X2YZ or XYZ where X, Y, Z can be elements of cobalt (Co), iron (Fe), nickel (Ni), aluminum (Al), germanium (Ge), gallium (Ga), gadolinium (Gd), manganese (Mn), etc. In some embodiment, magnet 220c may be formed of a paramagnetic material such as, for example, aluminum or platinum. In some embodiments, conductors 230-234, ground plane 430, via 435, and conductors 410, 420 may be formed of copper or any suitable conductive metal including aluminum, silver, and gold.

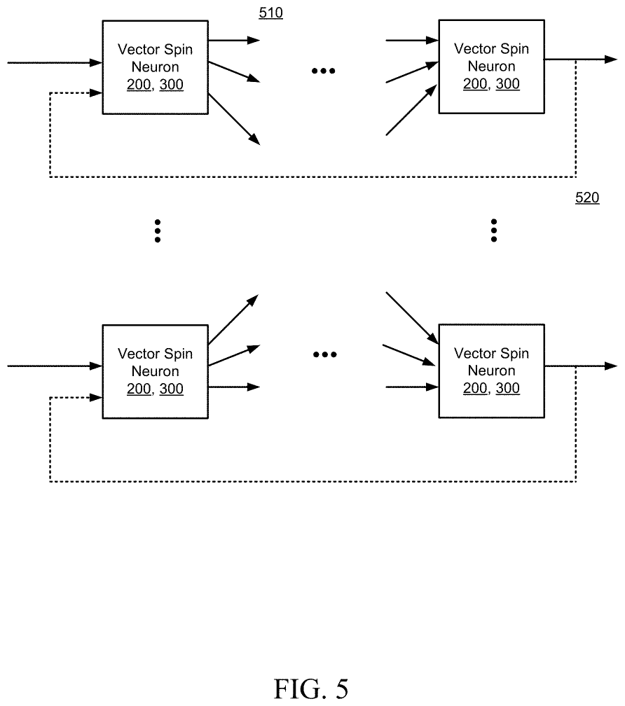

FIG. 5 is a block diagram of a capsule neural network 500, configured in accordance with certain embodiments of the present disclosure. The capsule neural network 500 may comprise any number of vector spin neurons 200, 300 which may be interconnected 510 in various configurations including one-to-one, one-to-many, many-to-one, and many-to-many. In some embodiments, the interconnections may also include feedback loops 520. In some embodiments, the network may also include scalar neurons (not shown).

Methodology

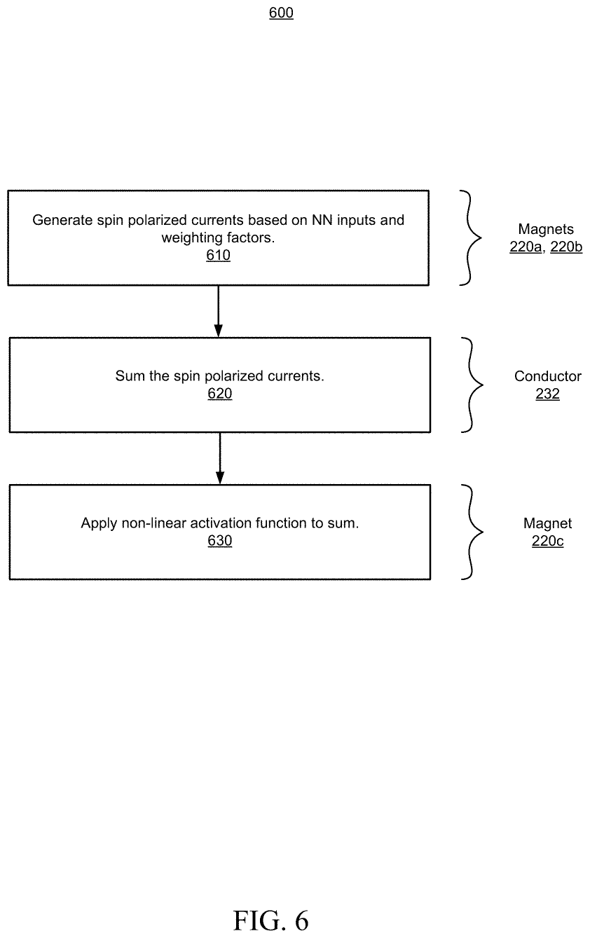

FIG. 6 is a flowchart illustrating an example method 600 for vector spin neuron processing, in accordance with certain embodiments of the present disclosure. As can be seen, the example method includes a number of phases and sub-processes, the sequence of which may vary from one embodiment to another. However, when considered in the aggregate, these phases and sub-processes form a process for vector spin neuron processing, in accordance with certain of the embodiments disclosed herein. These embodiments can be implemented, for example, using the system architecture illustrated in FIGS. 1-5, as described above. However other system architectures can be used in other embodiments, as will be apparent in light of this disclosure. To this end, the correlation of the various functions shown in FIG. 6 to the specific components illustrated in the other figures is not intended to imply any structural and/or use limitations. Rather, other embodiments may include, for example, varying degrees of integration wherein multiple functionalities are effectively performed by one system. Thus, other embodiments may have fewer or more modules and/or sub-modules depending on the granularity of implementation. Numerous variations and alternative configurations will be apparent in light of this disclosure.

As illustrated in FIG. 6, in an embodiment, method 600 for vector spin neuron processing commences at operation 610, by generating orthogonally spin polarized currents based on input currents that are controlled by NN inputs and NN weighting factors. In some embodiments, the NN weighting factors are elements of a rotation matrix.

Next, at operation 620, the spin polarized currents are summed, for example at a conductor junction point. At operation 630, the sum is provided to a non-polarized magnet configured to apply a non-linear activation function to the sum.

Of course, in some embodiments, additional operations may be performed, as previously described in connection with the system. For example, the input currents may be generated by a transistor, wherein the NN input value is based on a voltage applied to a source of the transistor and the NN weighting factor is based on a voltage applied to a gate of the transistor. Alternatively, in some embodiments, the input currents may be generated by a memristor, wherein the NN input value is based on a voltage applied to an input port of the memristor and the NN weighting factor is based on a conductance of the memristor. In some embodiments, multiple vector spin neurons may be interconnected in any desired network configuration to form a convolutional NN, a recursive NN, or any type of deep NN.

### Example System

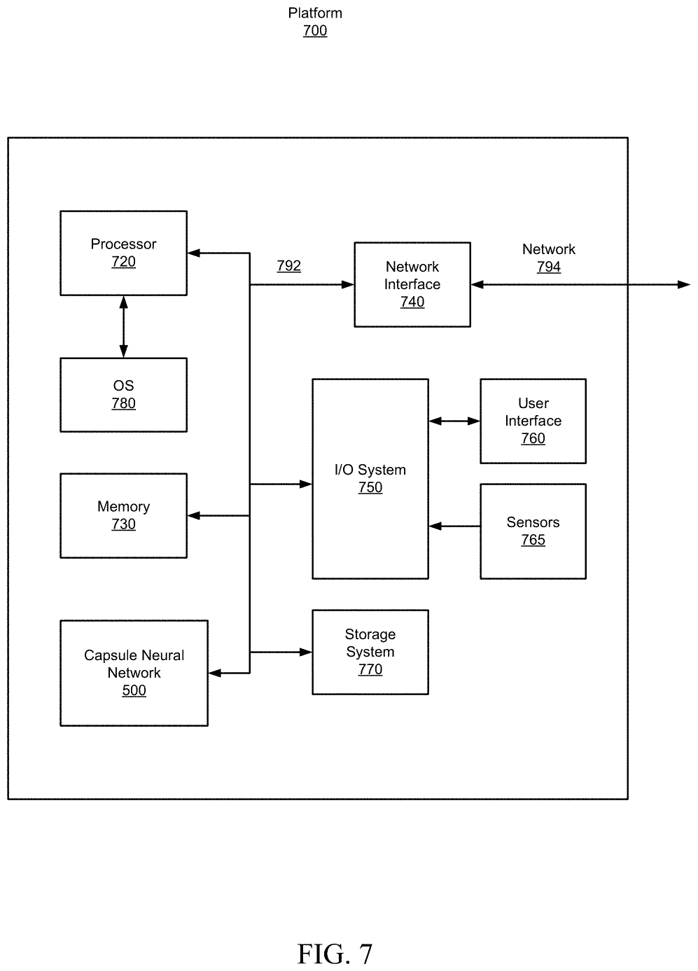

FIG. 7 illustrates an example device platform 700, configured in accordance with certain embodiments of the present disclosure, to employ a vector spin neuron implementation of a capsule neural network. In some embodiments, platform 700 may be hosted on, or otherwise be incorporated into a personal computer, workstation, server system, smart home management system, laptop computer, ultra-laptop computer, tablet, touchpad, portable computer, handheld computer, palmtop computer, personal digital assistant (PDA), cellular telephone, combination cellular telephone and PDA, smart device (for example, smartphone or smart tablet), mobile internet device (MID), messaging device, data communication device, wearable device, embedded system, and so forth. Any combination of different devices may be used in certain embodiments.

In some embodiments, platform 700 may comprise any combination of a processor 720, a memory 730, a capsule neural network 500 (comprising any number of vector spin neurons 200, 300), a network interface 740, an input/output (I/O) system 750, a user interface 760, sensors 765, and a storage system 770. As can be further seen, a bus and/or interconnect 792 is also provided to allow for communication between the various components listed above and/or other components not shown. Platform 700 can be coupled to a network 794 through network interface 740 to allow for communications with other computing devices, platforms, devices to be controlled, or other resources. Other componentry and functionality not reflected in the block diagram of FIG. 7 will be apparent in light of this disclosure, and it will be appreciated that other embodiments are not limited to any particular hardware configuration.

Processor 720 can be any suitable processor, and may include one or more coprocessors or controllers, such as an audio processor, a graphics processing unit, or hardware accelerator, to assist in control and processing operations associated with platform 700. In some embodiments, the processor 720 may be implemented as any number of processor cores. The processor (or processor cores) may be any type of processor, such as, for example, a micro-processor, an embedded processor, a digital signal processor (DSP), a graphics processor (GPU), a network processor, a field programmable gate array or other device configured to execute code. The processors may be multithreaded cores in that they may include more than one hardware thread context (or “logical processor”) per core. Processor 720 may be implemented as a complex instruction set computer (CISC) or a reduced instruction set computer (RISC) processor. In some embodiments, processor 720 may be configured as an x86 instruction set compatible processor.

Memory 730 can be implemented using any suitable type of digital storage including, for example, flash memory and/or random-access memory (RAM). In some embodiments, the memory 730 may include various layers of memory hierarchy and/or memory caches as are known to those of skill in the art. Memory 730 may be implemented as a volatile memory device such as, but not limited to, a RAM, dynamic RAM (DRAM), or static RAM (SRAM) device. Storage system 770 may be implemented as a non-volatile storage device such as, but not limited to, one or more of a hard disk drive (HDD), a solid-state drive (SSD), a universal serial bus (USB) drive, an optical disk drive, tape drive, an internal storage device, an attached storage device, flash memory, battery backed-up synchronous DRAM (SDRAM), and/or a network accessible storage device. In some embodiments, storage 770 may comprise technology to increase the storage performance enhanced protection for valuable digital media when multiple hard drives are included.

Processor 720 may be configured to execute an Operating System (OS) 780 which may comprise any suitable operating system, such as Google Android (Google Inc., Mountain View, Calif.), Microsoft Windows (Microsoft Corp., Redmond, Wash.), Apple OS X (Apple Inc., Cupertino, Calif.), Linux, or a real-time operating system (RTOS). As will be appreciated in light of this disclosure, the techniques provided herein can be implemented without regard to the particular operating system provided in conjunction with platform 700, and therefore may also be implemented using any suitable existing or subsequently-developed platform.

Network interface circuit 740 can be any appropriate network chip or chipset which allows for wired and/or wireless connection between other components of device platform 700 and/or network 794, thereby enabling platform 700 to communicate with other local and/or remote computing systems, servers, cloud-based servers, and/or other resources. Wired communication may conform to existing (or yet to be developed) standards, such as, for example, Ethernet. Wireless communication may conform to existing (or yet to be developed) standards, such as, for example, cellular communications including LTE (Long Term Evolution), Wireless Fidelity (Wi-Fi), Bluetooth, and/or Near Field Communication (NFC). Exemplary wireless networks include, but are not limited to, wireless local area networks, wireless personal area networks, wireless metropolitan area networks, cellular networks, and satellite networks.

I/O system 750 may be configured to interface between various I/O devices and other components of device platform 700. I/O devices may include, but not be limited to, user interface 760 and sensors 765. User interface 760 may include devices (not shown) such as a speaker, microphone, display element, touchpad, keyboard, and mouse, etc. Sensors 765 may include any type of data acquisition circuits or mechanisms configured to provide data, for example to be processed by the capsule neural network 500. I/O system 750 may include a graphics subsystem configured to perform processing of images for rendering on the display element. Graphics subsystem may be a graphics processing unit or a visual processing unit (VPU), for example. An analog or digital interface may be used to communicatively couple graphics subsystem and the display element. For example, the interface may be any of a high definition multimedia interface (HDMI), DisplayPort, wireless HDMI, and/or any other suitable interface using wireless high definition compliant techniques. In some embodiments, the graphics subsystem could be integrated into processor 720 or any chipset of platform 700.

It will be appreciated that in some embodiments, the various components of platform 700 may be combined or integrated in a system-on-a-chip (SoC) architecture. In some embodiments, the components may be hardware components, firmware components, software components or any suitable combination of hardware, firmware or software.

The capsule neural network 500 is configured to employ any number of vector spin neurons 200, 300, to perform vector operations on vector inputs, as described previously. The vector operations may include affine transformations, a weighting (rotation) operations, summation operations, and non-linear activation/thresholding operations. The vector spin neurons 200, 300 may include any or all of the circuits/components illustrated in FIGS. 1-4, as described above.

In various embodiments, platform 700 may be implemented as a wireless system, a wired system, or a combination of both. When implemented as a wireless system, platform 700 may include components and interfaces suitable for communicating over a wireless shared media, such as one or more antennae, transmitters, receivers, transceivers, amplifiers, filters, control logic, and so forth. An example of wireless shared media may include portions of a wireless spectrum, such as the radio frequency spectrum and so forth. When implemented as a wired system, platform 700 may include components and interfaces suitable for communicating over wired communications media, such as input/output adapters, physical connectors to connect the input/output adaptor with a corresponding wired communications medium, a network interface card (NIC), disc controller, video controller, audio controller, and so forth. Examples of wired communications media may include a wire, cable metal leads, printed circuit board (PCB), backplane, switch fabric, semiconductor material, twisted pair wire, coaxial cable, fiber optics, and so forth.

Various embodiments may be implemented using hardware elements, software elements, or a combination of both. Examples of hardware elements may include processors, microprocessors, circuits, circuit elements (for example, transistors, resistors, capacitors, inductors, and so forth), integrated circuits, ASICs, programmable logic devices, digital signal processors, FPGAs, logic gates, registers, semiconductor devices, chips, microchips, chipsets, and so forth. Examples of software may include software components, programs, applications, computer programs, application programs, system programs, machine programs, operating system software, middleware, firmware, software modules, routines, subroutines, functions, methods, procedures, software interfaces, application program interfaces, instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power level, heat tolerances, processing cycle budget, input data rates, output data rates, memory resources, data bus speeds, and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

The various embodiments disclosed herein can be implemented in various forms of hardware, software, firmware, and/or special purpose processors. For example, in one embodiment at least one non-transitory computer readable storage medium has instructions encoded thereon that, when executed by one or more processors, cause one or more of the methodologies disclosed herein to be implemented. The instructions can be encoded using a suitable programming language, such as C, C++, object oriented C, Java, JavaScript, Visual Basic .NET, Beginner's All-Purpose Symbolic Instruction Code (BASIC), or alternatively, using custom or proprietary instruction sets. The instructions can be provided in the form of one or more computer software applications and/or applets that are tangibly embodied on a memory device, and that can be executed by a computer having any suitable architecture. In one embodiment, the system can be hosted on a given website and implemented, for example, using JavaScript or another suitable browser-based technology. For instance, in certain embodiments, the system may leverage processing resources provided by a remote computer system accessible via network 794. In other embodiments, the functionalities disclosed herein can be incorporated into other applications, such as, for example, image recognition systems, automobile control/navigation, smart-home management, entertainment, and robotic applications. The applications disclosed herein may include any number of different modules, sub-modules, or other components of distinct functionality, and can provide information to, or receive information from, still other components. These modules can be used, for example, to communicate with input and/or output devices such as a display screen, a touch sensitive surface, a printer, and/or any other suitable device. Other componentry and functionality not reflected in the illustrations will be apparent in light of this disclosure, and it will be appreciated that other embodiments are not limited to any particular hardware or software configuration. Thus, in other embodiments platform 700 may comprise additional, fewer, or alternative subcomponents as compared to those included in the example embodiment of FIG. 7.

The aforementioned non-transitory computer readable medium may be any suitable medium for storing digital information, such as a hard drive, a server, a flash memory, and/or random-access memory (RAM), or a combination of memories. In alternative embodiments, the components and/or modules disclosed herein can be implemented with hardware, including gate level logic such as a field-programmable gate array (FPGA), or alternatively, a purpose-built semiconductor such as an application-specific integrated circuit (ASIC). Still other embodiments may be implemented with a microcontroller having a number of input/output ports for receiving and outputting data, and a number of embedded routines for carrying out the various functionalities disclosed herein. It will be apparent that any suitable combination of hardware, software, and firmware can be used, and that other embodiments are not limited to any particular system architecture.

Some embodiments may be implemented, for example, using a machine readable medium or article which may store an instruction or a set of instructions that, if executed by a machine, may cause the machine to perform a method, process, and/or operations in accordance with the embodiments. Such a machine may include, for example, any suitable processing platform, computing platform, computing device, processing device, computing system, processing system, computer, process, or the like, and may be implemented using any suitable combination of hardware and/or software. The machine readable medium or article may include, for example, any suitable type of memory unit, memory device, memory article, memory medium, storage device, storage article, storage medium, and/or storage unit, such as memory, removable or non-removable media, erasable or non-erasable media, writeable or rewriteable media, digital or analog media, hard disk, floppy disk, compact disk read only memory (CD-ROM), compact disk recordable (CD-R) memory, compact disk rewriteable (CD-RW) memory, optical disk, magnetic media, magneto-optical media, removable memory cards or disks, various types of digital versatile disk (DVD), a tape, a cassette, or the like. The instructions may include any suitable type of code, such as source code, compiled code, interpreted code, executable code, static code, dynamic code, encrypted code, and the like, implemented using any suitable high level, low level, object oriented, visual, compiled, and/or interpreted programming language.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical entities within the registers, memory units, or other such information storage transmission or displays of the computer system. The embodiments are not limited in this context.

The terms “circuit” or “circuitry,” as used in any embodiment herein, are functional and may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smart phones, etc. Other embodiments may be implemented as software executed by a programmable control device. In such cases, the terms “circuit” or “circuitry” are intended to include a combination of software and hardware such as a programmable control device or a processor capable of executing the software. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Numerous specific details have been set forth herein to provide a thorough understanding of the embodiments. It will be understood by an ordinarily-skilled artisan, however, that the embodiments may be practiced without these specific details. In other instances, well known operations, components and circuits have not been described in detail so as not to obscure the embodiments. It can be appreciated that the specific structural and functional details disclosed herein may be representative and do not necessarily limit the scope of the embodiments. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

### Further Example Embodiments

The following examples pertain to further embodiments, from which numerous permutations and configurations will be apparent.

Example 1 is a capsule neural network (NN) comprising one or more vector neurons, the vector neurons to perform vector operations on vector inputs, the vector operations including an affine transformation, a weighting operation, a summation operation, and/or a non-linear activation.

Example 2 includes the subject matter of Example 1, wherein the capsule NN is at least one of a convolutional NN, a recursive NN, and a deep NN.

Example 3 includes the subject matter of Examples 1 or 2, wherein the vector neuron is a vector spin neuron, the vector spin neuron comprising: a first magnet to receive a first input current wherein the first magnet is polarized in a first direction and the first input current is based on a first NN input value and a first NN weighting factor; and a second magnet to receive a second input current wherein the second magnet is polarized in a second direction, the second direction orthogonal to the first direction, and the second input current is based on a second NN input value and a second NN weighting factor.

Example 4 includes the subject matter of any of Examples 1-3, wherein the first magnet is to generate a first spin polarized current at the output region of the first magnet, the first spin polarized current based on the first input current, and the second magnet is to generate a second spin polarized current at the output region of the second magnet, the second spin polarized current based on the second input current.

Example 5 includes the subject matter of any of Examples 1-4, further comprising: a third magnet, wherein the third magnet is unpolarized; and a conductor to couple an output region of the first magnet to an output region of the second magnet and further to an input region of the third magnet, wherein the conductor is further to sum the first spin polarized current and the second spin polarized current and provide the sum to the input region of the third magnet.

Example 6 includes the subject matter of any of Examples 1-5, wherein the third magnet is to apply a non-linear activation function to the sum of the first spin polarized current and the second spin polarized current to generate an output of the vector spin neuron.

Example 7 includes the subject matter of any of Examples 1-6, wherein the first NN weighting factor and the second NN weighting factor are elements of a rotation matrix.

Example 8 includes the subject matter of any of Examples 1-7, further comprising a transistor coupled to an input region of the first magnet, the transistor to provide the first input current, wherein the first NN input value is based on a voltage applied to a source of the transistor and the first NN weighting factor is based on a voltage applied to a gate of the transistor.

Example 9 includes the subject matter of any of Examples 1-8, further comprising a memristor coupled to an input region of the first magnet, the memristor to provide the first input current, wherein the first NN input value is based on a voltage applied to an input port of the memristor and the first NN weighting factor is based on a conductance of the memristor.

Example 10 is an integrated circuit or chip set comprising the capsule NN of any of Examples 1-9.

Example 11 is processor comprising the capsule NN of any of Examples 1-9.

Example 12 is an image processing system comprising the capsule NN of any of Examples 1-9.

Example 13 is a vector spin neuron comprising: a first magnet to receive a first input current wherein the first magnet is polarized in a first direction and the first input current is based on a first neural network (NN) input value and a first NN weighting factor; a second magnet to receive a second input current wherein the second magnet is polarized in a second direction, the second direction orthogonal to the first direction, and the second input current is based on a second NN input value and a second NN weighting factor; a third magnet, wherein the third magnet is unpolarized; and a conductor to couple an output region of the first magnet to an output region of the second magnet and further to an input region of the third magnet.

Example 14 includes the subject matter of Example 13, wherein the first magnet is to generate a first spin polarized current at the output region of the first magnet, the first spin polarized current based on the first input current, and the second magnet is to generate a second spin polarized current at the output region of the second magnet, the second spin polarized current based on the second input current.

Example 15 includes the subject matter of Examples 13 or 14, wherein the conductor is to sum the first spin polarized current and the second spin polarized current and provide the sum to the input region of the third magnet.

Example 16 includes the subject matter of any of Examples 13-15, wherein the third magnet is to apply a non-linear activation function to the sum of the first spin polarized current and the second spin polarized current to generate an output of the vector spin neuron.

Example 17 includes the subject matter of any of Examples 13-16, wherein the first NN weighting factor and the second NN weighting factor are elements of a rotation matrix.

Example 18 includes the subject matter of any of Examples 13-17, further comprising a transistor coupled to an input region of the first magnet, the transistor to provide the first input current, wherein the first NN input value is based on a voltage applied to a source of the transistor and the first NN weighting factor is based on a voltage applied to a gate of the transistor.

Example 19 includes the subject matter of any of Examples 13-18, further comprising a memristor coupled to an input region of the first magnet, the memristor to provide the first input current, wherein the first NN input value is based on a voltage applied to an input port of the memristor and the first NN weighting factor is based on a conductance of the memristor.

Example 20 includes the subject matter of any of Examples 13-19, the vector spin neurons are to perform vector operations on vector inputs, the vector operations including at least one of an affine transformation, a weighting operation, a summation operation, and a non-linear activation.

Example 21 is an integrated circuit capsule NN comprising two or more of the vector spin neurons of any of Examples 13-20.

Example 22 includes the subject matter of Example 21, wherein the capsule NN is at least one of a convolutional NN, a recursive NN, and a deep NN.

Example 23 is a chip set comprising the integrated circuit capsule NN of Examples 21 or 22.

Example 24 is a processor comprising the integrated circuit capsule NN of Examples 21 or 22.

Example 25 is an image processing system comprising the integrated circuit capsule NN of Examples 21 or 22.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner, and may generally include any set of one or more elements as variously disclosed or otherwise demonstrated herein.

What is claimed is:

1. A capsule neural network (NN) comprising:
one or more vector neurons, the vector neurons to perform vector operations on vector inputs, the vector operations including an affine transformation, a weighting operation, a summation operation, and/or a non-linear activation.

2. The capsule NN of claim 1, wherein the capsule NN is at least one of a convolutional NN, a recursive NN, and a deep NN.

3. The capsule NN of claim 1, wherein the vector neuron is a vector spin neuron, the vector spin neuron comprising:
a first magnet to receive a first input current wherein the first magnet is polarized in a first direction and the first input current is based on a first NN input value and a first NN weighting factor; and
a second magnet to receive a second input current wherein the second magnet is polarized in a second direction, the second direction orthogonal to the first direction, and the second input current is based on a second NN input value and a second NN weighting factor.

4. The capsule NN of claim 3, wherein the first magnet is to generate a first spin polarized current at the output region of the first magnet, the first spin polarized current based on the first input current, and the second magnet is to generate a second spin polarized current at the output region of the second magnet, the second spin polarized current based on the second input current.

5. The capsule NN of claim 4, further comprising:
a third magnet, wherein the third magnet is unpolarized; and
a conductor to couple an output region of the first magnet to an output region of the second magnet and further to an input region of the third magnet, wherein the conductor is further to sum the first spin polarized current and the second spin polarized current and provide the sum to the input region of the third magnet.

6. The capsule NN of claim 5, wherein the third magnet is to apply a non-linear activation function to the sum of the first spin polarized current and the second spin polarized current to generate an output of the vector spin neuron.

7. The capsule NN of claim 3, wherein the first NN weighting factor and the second NN weighting factor are elements of a rotation matrix.

8. The capsule NN of claim 3, further comprising a transistor coupled to an input region of the first magnet, the transistor to provide the first input current, wherein the first NN input value is based on a voltage applied to a source of the transistor and the first NN weighting factor is based on a voltage applied to a gate of the transistor.

9. The capsule NN of claim 3, further comprising a memristor coupled to an input region of the first magnet, the memristor to provide the first input current, wherein the first NN input value is based on a voltage applied to an input port of the memristor and the first NN weighting factor is based on a conductance of the memristor.

10. An integrated circuit or chip set comprising the capsule NN of claim 1.

11. A processor comprising the capsule NN of claim 1.

12. An image processing system comprising the capsule NN of claim 1.

13. A vector spin neuron comprising:
a first magnet to receive a first input current wherein the first magnet is polarized in a first direction and the first input current is based on a first neural network (NN) input value and a first NN weighting factor;
a second magnet to receive a second input current wherein the second magnet is polarized in a second direction, the second direction orthogonal to the first direction, and the second input current is based on a second NN input value and a second NN weighting factor;
a third magnet, wherein the third magnet is unpolarized; and
a conductor to couple an output region of the first magnet to an output region of the second magnet and further to an input region of the third magnet.

14. The vector spin neuron of claim 13, wherein the first magnet is to generate a first spin polarized current at the output region of the first magnet, the first spin polarized current based on the first input current, and the second magnet is to generate a second spin polarized current at the output region of the second magnet, the second spin polarized current based on the second input current.

15. The vector spin neuron of claim 14, wherein the conductor is to sum the first spin polarized current and the second spin polarized current and provide the sum to the input region of the third magnet.

16. The vector spin neuron of claim 15, wherein the third magnet is to apply a non-linear activation function to the sum of the first spin polarized current and the second spin polarized current to generate an output of the vector spin neuron.

17. The vector spin neuron of claim 13, wherein the first NN weighting factor and the second NN weighting factor are elements of a rotation matrix.

18. The vector spin neuron of claim 13, further comprising a transistor coupled to an input region of the first magnet, the transistor to provide the first input current, wherein the first NN input value is based on a voltage applied to a source of the transistor and the first NN weighting factor is based on a voltage applied to a gate of the transistor.

19. The vector spin neuron of claim 13, further comprising a memristor coupled to an input region of the first magnet, the memristor to provide the first input current, wherein the first NN input value is based on a voltage applied to an input port of the memristor and the first NN weighting factor is based on a conductance of the memristor.

20. The vector spin neuron of claim 13, the vector spin neurons are to perform vector operations on vector inputs, the vector operations including at least one of an affine transformation, a weighting operation, a summation operation, and a non-linear activation.

21. An integrated circuit capsule NN comprising two or more of the vector spin neurons of claim 13.

22. The integrated circuit capsule NN of claim 21, wherein the capsule NN is at least one of a convolutional NN, a recursive NN, and a deep NN.

23. A chip set comprising the integrated circuit capsule NN of claim 21.

24. A processor comprising the integrated circuit capsule NN of claim 21.

25. An image processing system comprising the integrated circuit capsule NN of claim 21.
